(19) United States
(12) Patent Application Publication
(10) Pub. No.: US 2003/0139900 A1
(43) Pub. Date: Jul. 24, 2003

(54) Methods and apparatus for statistical analysis

(76) Inventor: Terry Robison, Citrus Heights, CA (US)

Correspondence Address: HEWLETT-PACKARD COMPANY, Intellectual Property Administration, P.O. Box 272400, Fort Collins, CO, 80527-2400, US

(21) Appl. No.: 10/022,785

(22) Filed: Dec. 17, 2001

(51) Int. Cl. G06F 17/18

(52) U.S. Cl. 702/179

(57) ABSTRACT

A computing apparatus having a processor coupled to a memory. The memory has a data structure stored therein representing a set of summarized metrics of a plurality of data elements. The data structure includes: (a) an indication of an average value of the plurality of data elements; (b) a count value indicating a number of data elements in the plurality of data elements; (c) an indication of a minimum value and a maximum value of the plurality of data elements; and (d) an indication of a standard deviation of the plurality of data elements.

### FIELD OF THE INVENTION

The present invention relates to methods and apparatus for performing statistical analysis of data, and more particularly to methods and apparatus for statistically characterizing capacity and performance of storage area networks (SANs).

### BACKGROUND OF THE INVENTION

A storage area network is a high-speed, high-bandwidth inter-server network utilizing integrated hardware (usually fibre channel) and software to provide a robust, high-speed storage backbone. A SAN enables clusters of servers to share storage arrays with exclusive data access or to share data on common storage devices, depending on the SAN topology. SAN networks are useful, for example, in fully networked enterprises that require storage of terabytes of information collected on each customer and each transaction. The need for high availability and security of data adds to escalating requirements. Storage area networks (SANs) offer very high-speed, high-availability pools of storage that can be shared throughout an enterprise, yet managed through simplified operations.

SANs include large collections of storage elements, such as multiple hard disk drives. To ensure optimum performance in known SANs, data and performance metrics are gathered. These metrics are used to determine performance trends and statistics that are used to anticipate possible problems (such as bandwidth bottlenecks) so that measures can be taken to alleviate the problems before they occur. However, different SAN products implement new versions of statistical manipulation software, each of which must be separately tested and debugged. Moreover, data types (e.g., int, double, long) used for gathering of performance metrics differ from one implementation to the next. These different data types are handled by a universal conversion to double, which is not appropriate in all cases. For example, it is not appropriate for a statistical analysis to return a value that includes fractional numbers of bytes. When inappropriate values are returned, the likelihood of errors in coding of the statistical analysis packages the calculation of statistics increases. In addition, SAN measurements are not always available for uniform time intervals. This non-uniformity sometimes results in skewing of statistics and less than optimum extrapolation of performance trends.

### SUMMARY OF THE INVENTION

There is therefore provided, in one configuration of the present invention, a computing apparatus having a processor coupled to a memory. The memory has a data structure stored therein representing a set of summarized metrics of a plurality of data elements. The data structure includes: (a) an indication of an average value of the plurality of data elements; (b) a count value indicating a number of data elements in the plurality of data elements; (c) an indication of a minimum value and a maximum value of the plurality of data elements; and (d) an indication of a standard deviation of the plurality of data elements.

Another configuration of the present invention provides a machine readable medium or media having recorded thereon instructions configured to instruct a computing apparatus to store, in memory coupled to a processor, a data structure that includes: (a) an indication of an average value of a plurality of data elements; (b) a count value indicating a number of data elements in the plurality of data elements; (c) an indication of a minimum value and a maximum value of the plurality of data elements; and (d) an indication of a standard deviation of the plurality of data elements.

Yet another configuration of the present invention provides a method for storing a set of summarized metrics of a plurality of data elements. The method includes storing in a memory of a processor: (a) an indication of an average value of the plurality of data elements; (b) a count value indicating a number of data elements in the plurality of data elements; (c) an indication of a minimum value and a maximum value of the plurality of data elements; and (d) an indication of a standard deviation of the plurality of data elements.

Configurations of the present invention provide a framework for computation of statistical metrics can be performed with re-usable software objects and in which collecting and analyzing of many different types of statistics from many different types of systems can be performed. Configurations of the present invention are particularly useful for statistical analysis of storage area networks (SANs) and other networks in which measurements of metrics are not always available for consistent time intervals. Also, configurations of the present invention are useful as re-usable software objects for systems in which data types (e.g., int, double, long) of collected metrics (i.e., data elements) differ from one implementation to the next. Thus, the likelihood of errors in coding of the statistical analysis packages the calculation of statistics is reduced.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a relationship chart showing class relationships between GroupedMultivariateData, MultivariateData, GroupedDataElement, DataElement, and Comparable classes.

FIG. 2 is a relationship chart showing class relationships between DataSet, DataCollection, LinkedList, and TreeSet classes.

FIG. 3 is a chart showing class relationships between PolynomialRelationship, LinearRelationship, and Relationship.

FIG. 4 is a chart showing the class relationships between Number, MutableNumber, MutableInteger, MutableFloat, MutableDouble, MutableShort, MutableByte, and MutableLong classes.

FIG. 5 is a relationship chart illustrating relationships between MultivariateData, GroupedMultivariateData, BivariateDouble, GroupedBivariateDouble, UnivariateDoubleElement, BivariateDoubleElement, UnivariateDouble, and GroupedUnivariateDouble.

FIG. 6 is a block diagram of one configuration of a storage area network (SAN) including a computing device comprising a processor and a operatively coupled memory having data structures stored within that are instances of the GroupedDataElement class and the LinearRelationship class, and a medium on which machine readable instructions are recorded.

### DETAILED DESCRIPTION OF THE PREFERRED EMBODIMENTS

The following description of the preferred embodiment(s) is merely exemplary in nature and is in no way intended to limit the invention, its application, or uses.

In one configuration, a statistics package is a set of classes used for the purpose of performing statistical tests. Although this set of classes is suitable for use in general statistical modeling, in one configuration, the set of classes is used to provide enhanced manipulation of data gathered over a storage area network (SAN). The statistics package in this configuration provides basic interfaces, including DataElement, a building block of the statistics package, Relationship, a definition of a derived relationship between one or more independent variables and one or more dependent variables, DataCollection, a class used to group a set of DataElements together, and Statistics, a set of static methods for manipulating DataCollections to obtain Relationships and other useful measurements.

The Statistics class in one embodiment provides several static methods for getting relationships, performing grouping, data reduction, and variance testing over a collection of data elements. The Statistics class in one configuration includes a set of static methods for manipulating DataCollections to obtain Relationships and other useful measurements. Also in one configuration, the Statistics class also provides static methods for performing grouping, data reduction, and variance testing over a collection of data elements. The static methods in the Statistics class in this configuration include:

getMean(in data:DataCollection):DataElement

getRelationship(in data:in confidence double):Relationship

getRange(in data:DataCollection):DataElement

getStandardDeviation(in data:DataCollection):DataElement

getSum(in data:DataCollection):DataElement

group(in data:DataCollection, in index:int, in interval:Number):DataSet

inSample(in data:DataCollection, in confidence:double):boolean

reduceData(in data:DataCollection, in isDiscrete:boolean):DataSet

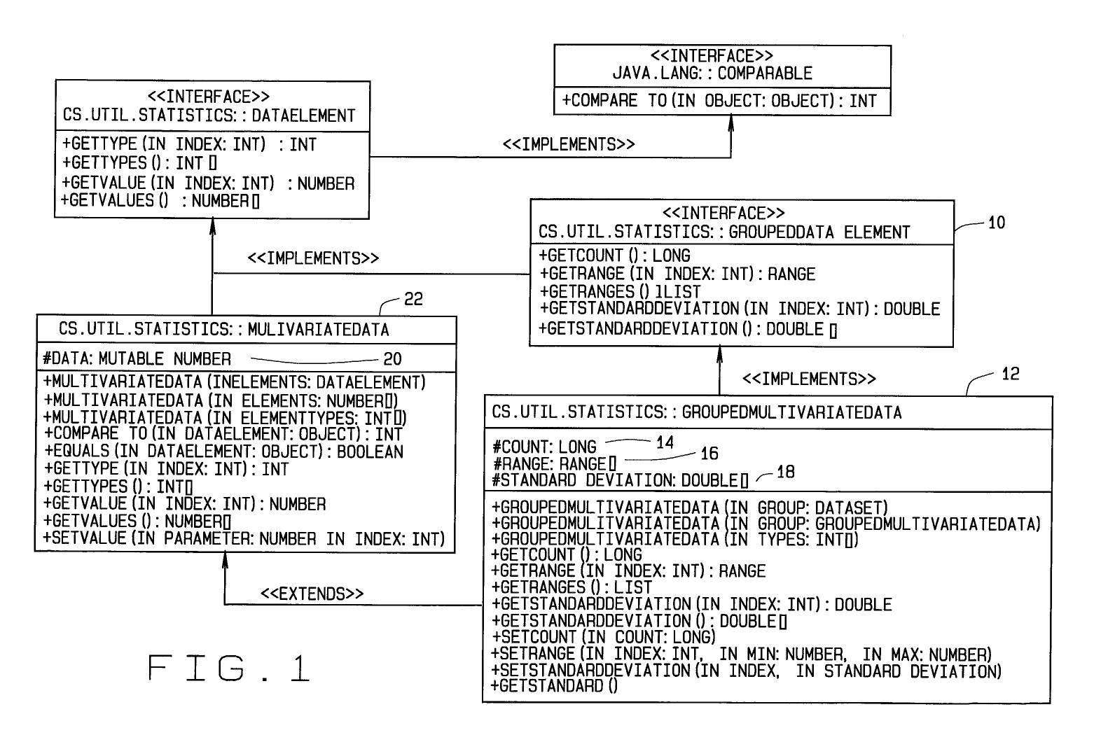

FIG. 1 is a relationship chart showing class relationships between GroupedMultivariateData 12, MultivariateData 22, GroupedDataElement 10, DataElement, and Comparable classes. The DataElement class and GroupedDataElement class 10 are representations of data. Because of their relationships, each instance of a GroupedDataElement includes member elements count 14, range 16, standardDeviation 18, and data 20 which are inherited from GroupedMultivariateData 12 and MultivariateData 22.

A DataElement is an ordered set of tuples. Each tuple is a pair consisting of a numeric type and a numeric value. Each DataElement can have zero or more tuples. For example, the DataElement {[0, int][1.1, float], [1.2, double]} corresponds to the set of numeric values {0, 1.1F, 1.2}.

A GroupedDataElement 10 is a single data element corresponding to a summarized metric. The summarized metric has an associated average value, count, range, and standard deviation. In one configuration, these values are stored as a data structure in a memory of a computing apparatus comprising a processor operatively coupled to a memory. The average value 20 in one configuration is an average of a plurality of data elements (such as those representing performance metrics of a storage area network or SAN), and is itself an instance of a MutableNumber object comprising a stored alterable value of a primitive numeric type. Also, the range in one configuration is a Range 16 object indicating a minimum and a maximum value of the plurality of data elements and comprises two instances of MutableNumber objects. Some DataElements are also GroupedDataElements 10. These are DataElements having numeric values corresponding to the mean value of a group of DataElements. GroupedDataElements 10 have associated with them a count 14, a standard deviation 18 for each tuple, and a range 16 for each tuple. All values of the GroupedDataElement 10 are based on a set of data elements from which they originate. In one configuration, a Range object 16 represents each range. Range object 16 includes a minimum number and a maximum number. For example, a series of DataElements {{0,3}, {1,6}, {2,3}} when reduced results in a GroupedDataElement 10 having mean values {1,4}, wherein the first value 1 in the GroupedDataElement is the mean of the first values {0, 1, 2} in the DataElement tuples and the second value 4 corresponds to the mean of the second values {3, 6, 3} of the DataElement tuples. Because the GroupedDataElement in this example is derived from three DataElements, it has a count of 3. In addition, the GroupedDataElement also has a standard deviation and range for each tuple. In this example, the standard deviation is {1.0, 3), with ranges of {[0,2], [3,6]}.

In one configuration, each DataElement has a natural order. DataElements are ordered by their numeric value in the ordered set from a value having a lowest index. For example, a series of DataElements {{2, −3}, {0,3}, {1,0}} is ordered {{0,3}, {1,0}, {2,−3}}. Also in configuration, if two DataElements have the same beginning numeric values, but one DataElement has fewer numeric values than another, the DataElement having fewer values is ordered before the DataElement having more. Thus, the series of DataElements {{2,−3}, {2}, {2,−3, 0}} is ordered {{2}, {2,−3}, {2,−3, 0}}. When two DataElements have the same value and the same number of values, the type of values is used to determine their order. When ordered using types of values, DataElements are ordered, from first to last, byte, short, integer, long, float, double. Thus, for example, a series of DataElements {{2L}, {2}, {2.0F}} is ordered {{2}, {2L}, {2.0F}}. OnlyDataElements with the same number of elements, and for which the each element is of the same numeric type and value, are considered as being the same and equal. Thus, DataElements {2F, 0L} and {2F, 0L} are considered equal, but neither of these DataElements are equal to DataElements {2F, 0L, 2} or {2.0, 0}. No distinction is made between a DataElement and a GroupedDataElement in ordering.

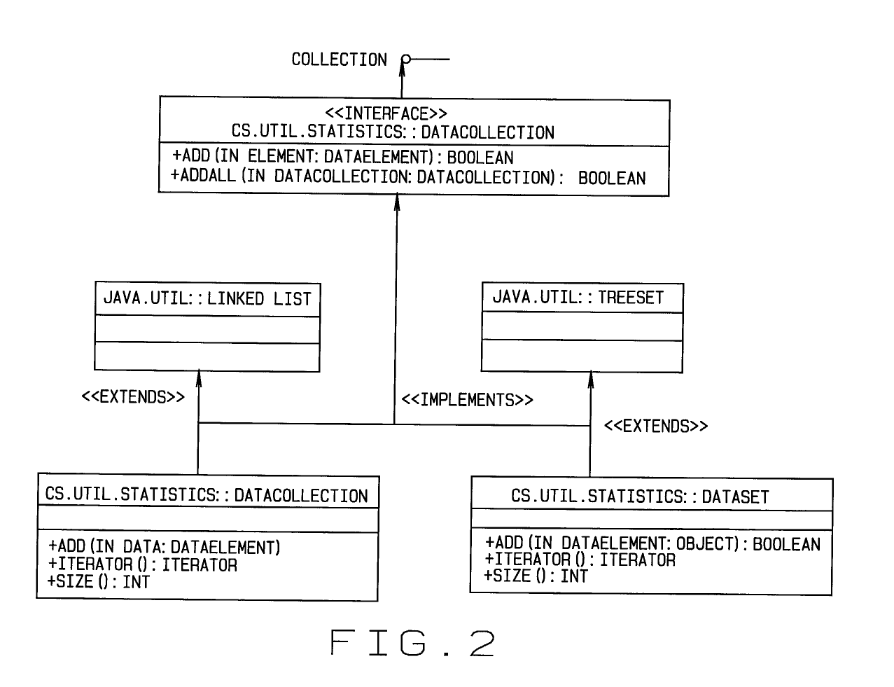

FIG. 2 is a relationship chart showing class relationships between DataSet, DataCollection, LinkedList, and TreeSet. DataCollection is a class used to group a set of DataElements together. DataCollections are groups of DataElements that are to be manipulated in some manner, for example, to test a condition, to derive a relationship between data points, or to determine a set of summarized metrics. A DataCollection is an unordered set of DataElements. DataCollections, in one configuration, are used to manipulate sets of DataElements. Also in one configuration, when DataElements are added to a collection, they are copied to speed processing and to allow direct access to reading of values of DataElements.

A DataSet is an ordered set of DataElements all with the same number of elements. Because a DataElement is itself a set, a DataSet can be considered as a matrix, with each column in the matrix of the same numeric type. The DataSet class maintains all DataElements in sorted order. In one configuration, DataSets contain only unique (non-equal) DataElements. If a DataElement is added to a DataSet that contains a DataElement of the same value (according to the “equals” method), the first DataElement is removed. The two DataElements are then averaged to obtain a GroupedDataElement 10. This GroupedDataElement is then placed into the DataSet. Because DataElements and GroupedDataElements 10 are treated the same in regard to equality, DataElements having the same value as a GroupedDataElement 10 can be added to GroupedDataElement 10, thereby increasing its count.

DataSets are used in the manipulation of DataElements. In one configuration, DataSets perform calculations over the entire set of DataElements. DataSets can be used to group, to perform data reduction, to sum, and to extract ordered subsets of DataElements. Grouping is performed over one column of the set of DataElements in one configuration. Over this one column, all DataElements in the set are divided into subsets based on a preselected interval. These subsets are then averaged and a GroupedDataElement 10 is obtained. Data reduction in one embodiment is performed by retrieving the mean 20, range 16, standard deviation 18, or a combination of these values from a GroupedDataElement 10. Extraction of subsets is performed, in one embodiment, by using the natural ordering of the DataElements, and the ability of java.util::TreeSet to extract SortedSets based on provided intervals.

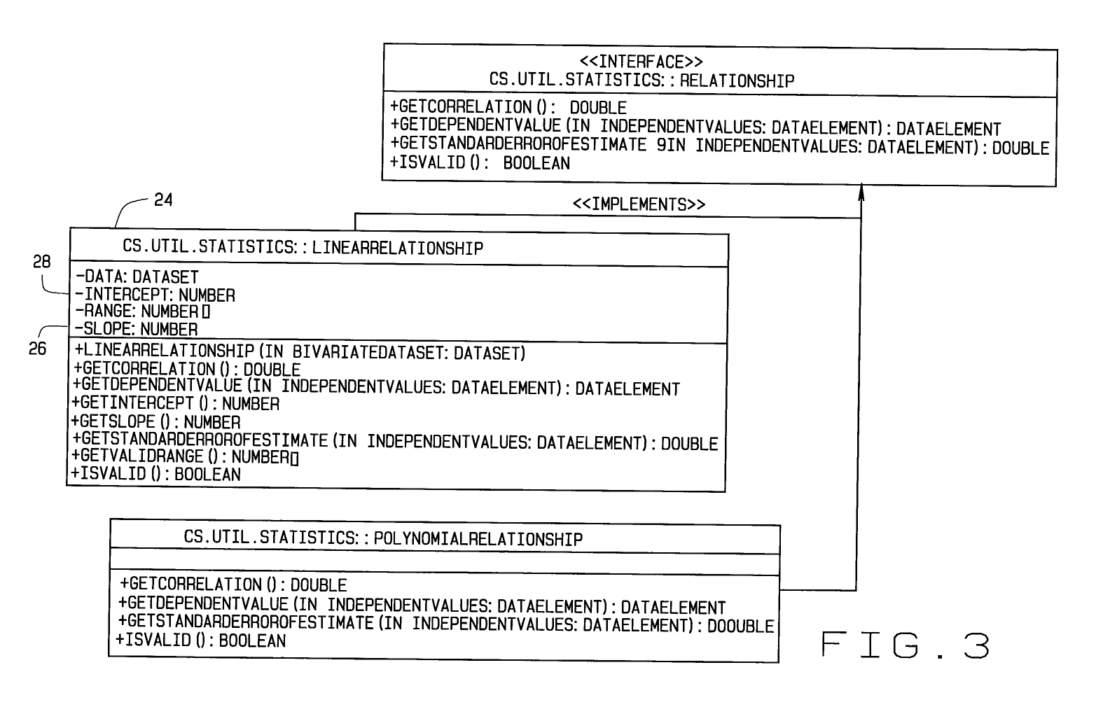

FIG. 3 is a chart showing class relationships between PolynomialRelationship, LinearRelationship 24, and Relationship in one configuration of the present invention. A Relationship defines a correspondence between a set of dependent variables and a single independent variable. Thus, estimates can be made using a Relationship. Each estimate has an associated standard error that is indicative of the accuracy of the estimate. Each Relationship also has a correlation that is indicative of how accurate the overall relationship is. This correlation is used to determine the value of is valid ( ) in a Relationship.

LinearRelationship 24 is a concrete implementation of Relationship corresponding to a linear relationship between X and Y type data. Each linear relationship has a slope 26 and a Y-intercept 28.

PolynomialRelationship is a concrete implementation of Relationship corresponding to a relationship of the form Y=Σax^{b}. In one configuration, the relationship is derived from a non-linear regression test on the collection of data points. The resulting set of data points from such a relationship is a curved line.

In one configuration, a relationship returned from the Statistics.getRelationship method is that relationship that provides a best fit for the data. The determination of best fit is based on a calculation of a deviation of predicted points from actual points at selected values (i.e., the calculated correlation factor).

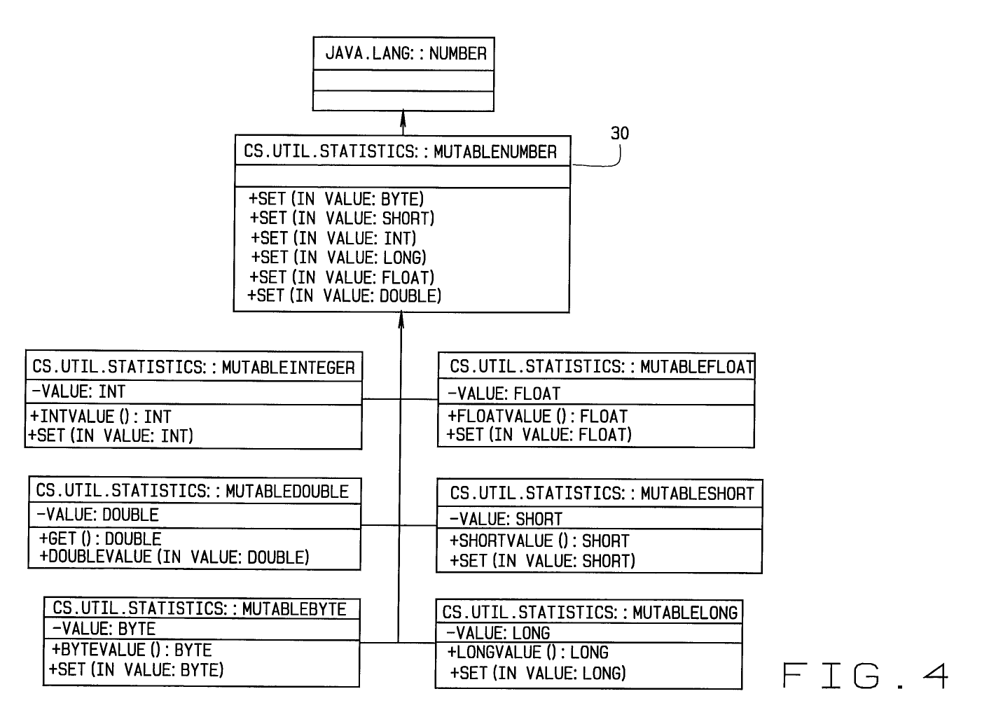

In one configuration of the present invention, a number of common data types are defined. FIG. 4 is a chart showing the class relationships between Number, MutableNumber 30, MutableInteger, MutableFloat, MutableDouble, MutableShort, MutableByte, and MutableLong classes in one configuration. MutableNumber 30 is a subclass of the java. lang. Number class. The MutableNumber class 30 of numbers provides manipulation of Number values, which is used to speed calculations that otherwise would have to rely on primitives or on creation of new Number values for each calculation. Functions are provided for each type of primitive, so that a computing apparatus using such functions is configured to perform computations on instances of MutableNumbers 30 in accordance with the primitive type stored therein, and to change values stored in a MutableNumber object 30 instance without changing the primitive type.

A Range 16 is a set of two MutableNumber 30 values corresponding to a minimum and a maximum value in a set of data. For example, the set of data {{3}, {4}, {100}, {−3}} has a {−3} and a maximum value of {100}. Methods in the Range class 16 in one configuration include:

Range(in min:Number, in max:Number)

getMin( ):Number

getMax( ):Number

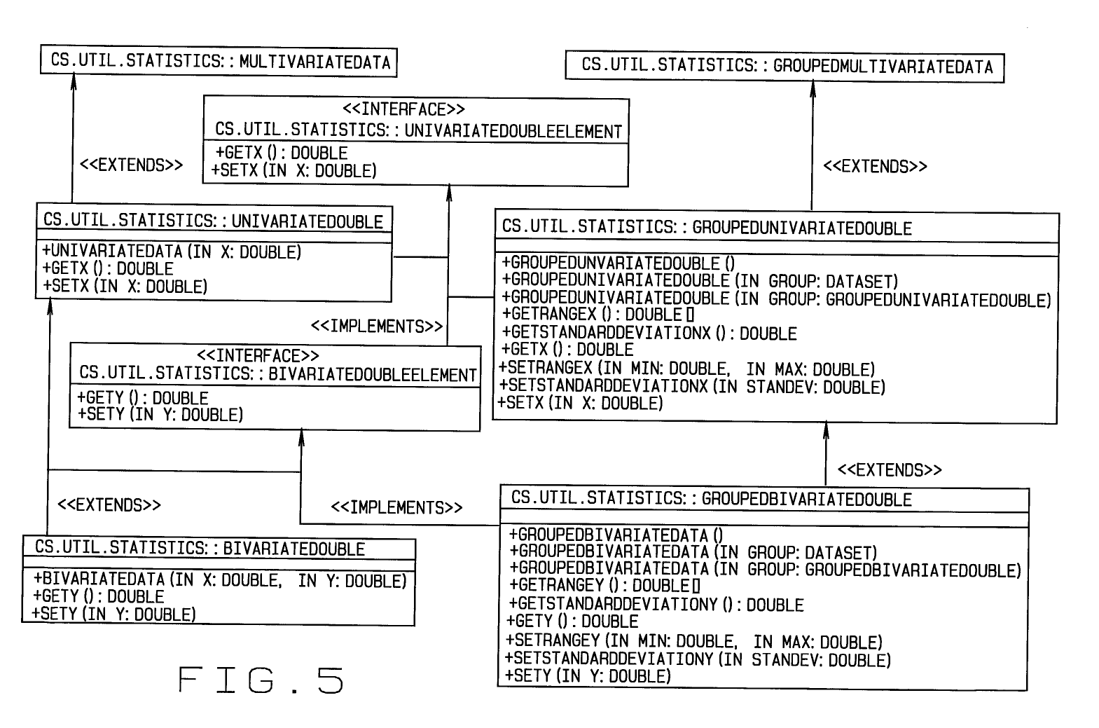

FIG. 5 is a relationship chart illustrating relationships between MultivariateData, GroupedMultivariateData, BivariateDouble, GroupedBivariateDouble, UnivariateDoubleElement, BivariateDoubleElement, UnivariateDouble, and GroupedUnivariateDouble. For graphing purposes, one configuration of the present invention specifies specific MultivariateData types that correspond to X and Y coordinates. Also, a UnivariateDouble data type is a DataElement of only one tuple, with a numeric type of double.

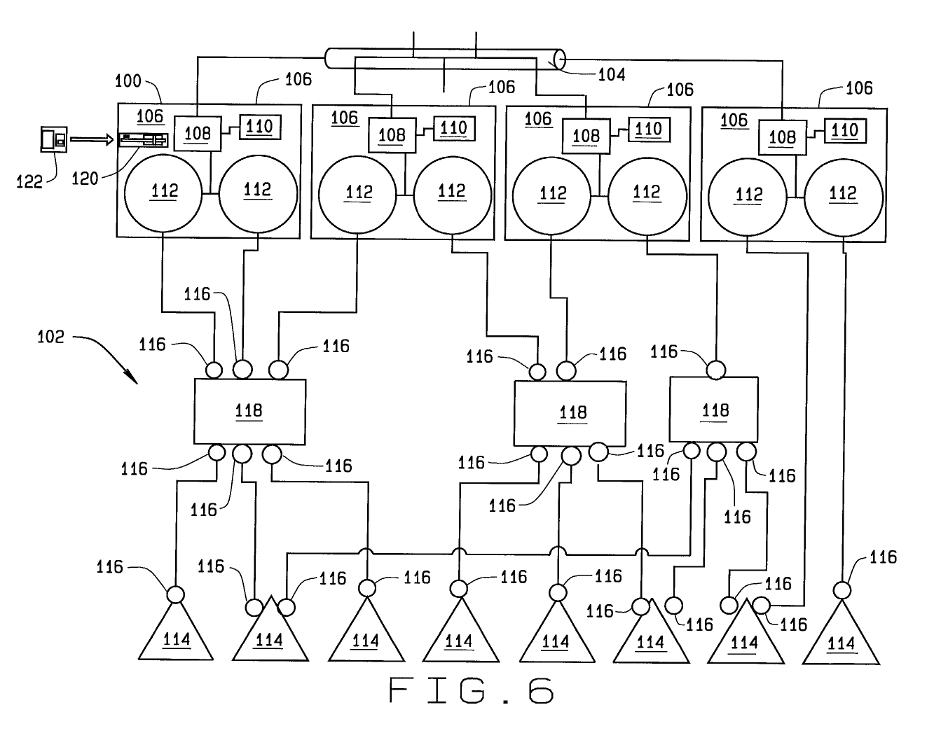

Configurations of the present invention are useful for collecting and analyzing many different types of statistics from many different types of systems. However, for illustrative purposes and referring to FIG. 6, let us consider a configuration of the present invention in a computing apparatus 100 configured to obtain data from a storage area network (SAN) 102, and in particular, to collect performance data or metrics from SAN 102 every ten minutes, including measurements of total available storage system capacity of SAN 102. This information may be collected, for example, out-of-band via a separate network such as an Ethernet network 104 via which computing apparatus 100 communicates non-storage data with other hosts 106 on SAN 102. (In another embodiment, information is collected in-band, via SAN 102 itself.) SAN 102 itself comprises hosts 106. As is known in a computing apparatus, each host 106 includes a processor 108 and an operatively coupled memory 110. Computing apparatus 100 in this example is also used as a host 106, but in another configuration not shown in FIG. 6, computing apparatus 100 is not used as a host. Each host 106 also includes one or more host bus adapters 112 that communicate storage data to and from storage devices 114 via ports 116 of hubs 118, or directly via ports 116 of storage devices 114.

For this example, consider a case in which the collection of data every ten minutes is not always successful. Let us assume that the data collection yields the results shown in Table I below.

TABLE I

| Time | Capacity (GBytes) | Time | Capacity (GBytes) |
|---|---|---|---|
| 1 hr 10 min | 120.0 | 2 hr 10 min | 200.9 |
| 1 hr 20 min | 130.1 | 3 hr 10 min | 300.9 |
| 1 hr 30 min | 140.3 | 4 hr 10 min | 300.2 |
| 1 hr 40 min | 100.4 | 5 hr 10 min | 200.0 |
| 1 hr 50 min | 110.5 | 6 hr 10 min | 300.1 |
| 2 hr | 120.7 | 7 hr 10 min | 200.9 |

Each set of time and capacity that is actually collected corresponds to a DataElement. The time at which a capacity measurement is made is represented by a long integer representing a time in milliseconds, and the capacity is represented as a double value. In one configuration, a DataElement to represent a first collected value at 1 hour, 10 minutes, is created using the commands:

DataElement capacityAt1hr10m;
capacityAt1hr10m = new MultivariateData (new Number[] {new

Long(70), new Double(120.0) });

This DataElement returns its first element of type Mathematics.LONG with a value of 70, corresponding to 1 hour, 10 minutes expressed in minutes, and its second element of type Mathematics.DOUBLE with a value of 120.0, corresponding to a capacity of 120 GBytes. To perform more interesting manipulation of the set of data points, all of the data being considered is added into a DataCollection. In this embodiment, the time and capacity data are contained within two arrays:

long [] time = {70, 80, 90, 100, 110, 120, 130, 190,

310, 370};

double [] capacity = {120.0, 130.1, 140.3, 100.4,

110.5, 120.7, 200.9, 300.9, 200.0, 300.1};

DataElement newData;
DataCollection capLast24Hrs = new DataSet ();
int [] type = {Mathematics.LONG, Mathematics.DOUBLE};
for (int x = 0; x < total; x++) {

newData = new MultivariateData(type);
newData.set(0, time[x]);
newData.set (1, capacity [x]);
capLast24Hr.add (newData);

}

After the data points are added to a DataCollection, an average of each hour of capacity collection is determined. Data is grouped by the first index (in which time is stored), and an iteration is performed over the resulting DataSet, which has data elements by the hour.

DataElement hrData;
DataSet capPerHr =

Statistics.group(capLast24Hr, 0, new Long(60));

Iterator capacityPerHr = capPerHr.iterator();
while (capacityPerHr.hasNext ()) {

hrData = (DataElement) capacityPrHr.next ();
System.out.println(

“Avg. Time: ” + hrData.getValue(0) .longValue() +
“Avg. Capacity: “ +

hrData.getValue (1) .doubleValue ());

}

In one embodiment, results are obtained, such as an overall average for an entire 24 hour time period, while ensuring that no one hour that happens to include more measurements than another hour is not given more weight than any other hour. The data collection is un-weighted, grouped first on time, and the reduced in the resulting DataSet. Note that avgFor24 Hrs is an instance of a GroupedDataElement that is determined by the computing apparatus using the plurality of data elements (i.e., metrics) which themselves are determined from values of performance measurements (i.e., metrics) from the storage area network.

capPerHr = Statistics.unweight(capLast24Hr);
capPerHr = Statistics.group(capPerHr, 0, new Long(60));
GroupedDataElement avgFor24Hrs =

Statistics.reduceData (capPerHr);

System.out.println(

“Avg. Capacity: ”

+ avgFor24Hrs.getValue (1) .doubleValue ()
+ “ +/−” + avgFor24Hrs.getStandardDeviation(1));

To find the best relationship between the data points and use that relationship to predict what the capacity will be in every day for seven days:

int [] typeTime = {Mathematics.LONG};
MultivariateData futureTime =

new MultivariateData(typeTime);

DataElement estimate;
Relationship bestFit =

Statistics.getRelationship (capLast24Hr);

for (int x = 1; x <=7; x++) {

futureTime.setValue (0, x*60*24);
estimate = bestFit.getDependentvalue(timeInFuture);
System.out.println(“Estimate for day ” + x

+ “ capacity : ”
+ estimate.getValue(0) .doubleValue ();

Those skilled in the art will recognize that configurations of the present invention provide statistical analysis capabilities that are independent of data source and type of data provided (e.g., INT, DOUBLE, LONG, etc.). These capabilities are provided in a reusable, object-oriented package that can be debugged and used in a SAN product, and reused without reinvention for each product, thereby reducing debug and development time.

In one configuration of the present invention, a computing apparatus 100 performs the steps indicated above using a stored program in its memory. In this manner, performance data of SAN 102 is collected and data structures representing instances of objects described herein are stored in memory 108 by processor 106 of apparatus 100. Memory 108 in one embodiment is a random access memory, but in other embodiments, memory 108 may comprise, in whole or in part, other types of memory, including hard disk memory, removable media memory, etc.

In one configuration of the present invention, a machine readable medium or media 122 (for example, one or more floppy diskettes or CD-ROMs) or other type of medium or media, is provided that has recorded thereon instructions, such as those in the example presented above or a version of such instructions in a code native to processor 108. These instructions are readable (for example, via floppy diskette or CD-ROM drive 120) by apparatus 100 and are configured to instruct computing apparatus 100 to perform the steps described herein, including storage of data structures in memory 108. The use of the term “medium or media” is intended to indicate that the instructions need not all be recorded, for example, on a single floppy diskette or CD-ROM 122, in recognition of the fact that many computer programs span multiple diskettes and/or CD-ROMs, or may even span a mixture of media types.

In another configuration of the present invention, a statistics software package is provided for a computer or a computing apparatus. Measurements from a database are abstracted by a set of JAVA™ data objects. Each object corresponds to a row in a database table. Measurement values can be of varying data types: long, int, double, and float. Each measurement conforms to a standard interface regardless of its data type for extracting its value using the DataElement interface from the Statistics package. Measurements are then extracted in accordance with criteria from a query and placed inside a DataCollection. These measurements are then manipulated using selected data analysis functions or methods. The type of measurements remain unchanged (in particular, except for measurements already of the type double, measurements are not automatically promoted to double. The resulting type of summations, predictions, or data reductions retain the types of the original measurements.

For example, a series of measurements are made on data I/O (input/output) and stored in a series of integer and long measurements within a database corresponding to I/O rate (an integer value) and a set time (a long value). In addition, a series of measurements on disk capacity are made and stored as a series of double and long measurements corresponding to disk capacity (a double value) and a set time (a long value). To perform summation, data reduction for long term archival of data, and trending on all three types of data, three separate classes are derived. The first takes a DataCollection and performs summation on it using a Statistics “getSum” method. A resulting DataElement is then used to create a Measurement of an appropriate type that is returned. A second class takes a DataCollection and performs data reduction using a Statistics “reduceData” method. A resulting GroupedDataElement is used to create a Measurement while all of the DataElements within the collection are deleted. A third class takes a DataCollection, determines a best fit relationship, and generates a set of data points to represent the best fit relationship, such as for a graph.

Each class described in connection with this example is configured to handle the different anticipated Measurement types appropriately, and are expandable to handle other Measurement types, and all DataElements in this particular example have exactly two elements.

Those skilled in the art will appreciate that the class of data DataElements is an abstraction that permits instances of data to be of different types, for example, bytes, doubles, reals, integers, or any other primitive type. Thus, any type of data may be handled by in an abstract way by instantiating classes with methods that handle particular primitive types. More particularly, the numbers representing statistical data are stored in a mutable class, i.e., one in which the numbers can be changed. Primitive values are encapsulated into mutable objects, also using mutable objects to abstract the type. For example, methods are provided to read and write values to mutable bytes and mutable doubles, whereas primitive type objects cannot be changed. Statistical operations are done on instances of the mutable classes of numbers rather than on the number objects or primitives that do not permit numbers to be changed. As a result, statistical operations are less expensive to perform in terms of computing resources than they would be if performed on primitive values, particularly when the primitive values are all promoted to a high-precision type (such as double). Because doubles, and conversions to and from doubles, produce complexity, uncertainty, and the possibility of rounding and range errors in some calculations, the use of mutable objects having the same or comparable precision to the data obtainable from the source of the statistical data can result in computations that are more accurate and/or less error-prone than result from the customary expedient of promoting all numbers to a high-precision type for intermediate computations.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A computing apparatus comprising a processor operatively coupled to a memory, said memory having a data structure stored therein representing a set of summarized metrics of a plurality of data elements, said data structure comprising:
(a) an indication of an average value of said plurality of data elements;
(b) a count value indicating a number of data elements in said plurality of data elements;
(c) an indication of a minimum value and a maximum value of said plurality of data elements; and
(d) an indication of a standard deviation of said plurality of data elements.

2. A computing apparatus in accordance with claim 1 further configured to obtain performance measurements of a storage area network and to determine values for said plurality of data elements using the performance measurements.

3. A computing apparatus in accordance with claim 2 wherein said indication of an average value of said plurality of data elements is an instance of an object comprising a stored alterable value of a primitive numeric type, said object thereby being a MutableNumber object.

4. A computing apparatus in accordance with claim 3 wherein said indication of said minimum value and said maximum value is an instance of an object comprising two instances of MutableNumber object.

5. A computing apparatus in accordance with claim 4 configured to perform computations using said instances of MutableNumber objects in accordance with the primitive numeric type stored therein, and to change values stored in said MutableNumber objects without changing said primitive numeric types.

6. A computing apparatus in accordance with claim 2 further configured to utilize said data structure to produce at least one of a performance summary of the storage area network or a prediction of the performance of the storage area network.

7. A computing apparatus in accordance with claim 6 wherein said performance measurements comprise available storage and corresponding elapsed times.

8. A computing apparatus in accordance with claim 6 wherein said memory further has stored therein an instance of an object comprising an ordered set of data elements and values representing a Y-intercept and slope of a best fit linear relationship of said ordered set of data elements.

9. A machine readable medium or media having recorded thereon instructions configured to instruct a computing apparatus having a processor and memory operatively coupled to the processor to store in the memory a data structure comprising:
(a) an indication of an average value of a plurality of data elements;
(b) a count value indicating a number of data elements in the plurality of data elements;
(c) an indication of a minimum value and a maximum value of the plurality of data elements; and
(d) an indication of a standard deviation of the plurality of data elements.

10. A medium or media in accordance with claim 9 further having recorded thereon instructions configured to query a storage area network for performance data, and to determine values of the plurality of data elements using the performance data.

11. A computing apparatus in accordance with claim 10 further having recorded thereon instructions configured to instruct the computing apparatus to store an instance of a object comprising a stored alterable value of a primitive numeric type as said indication of an average value, said object thereby being a MutableNumber object.

12. A medium or media in accordance with claim 11 further having recorded thereon instructions configured to instruct the computing apparatus to store an instance of an object comprising two instances of said MutableNumber objects as said indication of said minimum value and said maximum value.

13. A medium or media in accordance with claim 12 further having recorded thereon instructions configured to instruct the computing apparatus to perform computations using said instances of MutableNumber objects in accordance with the primitive numeric type stored therein, and to change values stored in said MutableNumber objects without changing said primitive numeric types.

14. A medium of media in accordance with claim 10 further having recorded thereon instructions configured to utilize said data structure to produce at least one of a performance summary of the storage area network or a prediction of the performance of the storage area network.

15. A medium or media in accordance with claim 10 wherein the instructions configured to query a storage area network for performance data are configured to query the storage area network to obtain measurements of available storage and corresponding elapsed time.

16. A medium or media in accordance with claim 14 further having recorded thereon instructions configured to instruct the computing apparatus to store in memory an instance of an object comprising an ordered set of data elements and values representing a Y-intercept and a slope of a best fit linear relationship of the ordered set of data elements, said object thereby being a LinearRelationship object; and to utilize said instance of said LinearRelationship object to indicate a summary of said performance data.

17. A method for storing a set of summarized metrics of a plurality of data elements comprising storing in a memory operatively coupled to a processor:
(a) an indication of an average value of the plurality of data elements;
(b) a count value indicating a number of data elements in the plurality of data elements;
(c) an indication of a minimum value and a maximum value of the plurality of data elements; and
(d) an indication of a standard deviation of the plurality of data elements.

18. A method in accordance with claim 17 further comprising querying a storage area network for performance data, and determining values of the plurality of data elements using the performance data.

19. A method in accordance with claim 18 wherein the indication of an average value of the plurality of data elements is an instance of an object comprising a stored alterable value of a primitive numeric type, said object thereby being a MutableNumber object, and the indication of the minimum value and the maximum value is an instance of an object comprising two instances of the MutableNumber objects.

20. A method in accordance with claim 19 further comprising utilizing said data structure to produce at least one of a performance summary of the storage area network or a prediction of the performance of the storage area network.
